(19) United States
(12) Patent Application Publication
(10) Pub. No.: US 2005/0201483 A1
(43) Pub. Date: Sep. 15, 2005

(54) Error adjustment for multi-antenna transmitter

(76) Inventor: Edmund Coersmeier, Bochum (DE)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/799,574

(22) Filed: Mar. 12, 2004

(51) Int. Cl. H04L 1/00

(52) U.S. Cl. 375/285; 370/206

(57) ABSTRACT

A processing device and method for an error adjustment system for equalizing transmission characteristics of N signal processing circuitries according to N signal branches (N>1) are disclosed. An original complex IQ signal of a signal branch of N signal branches and a processed real signal of the signal branch are received. A processed complex IQ signal of the signal branch is calculated from the processed real signal and the original complex IQ signal of the signal branch. Then, a difference between the processed complex IQ signal and the original complex IQ signal is calculated. Finally, control values of a correction function of the signal branch are calculated on the basis of the calculated difference. The calculated control values are supplied to the correction function of the signal branch. The receiving, calculating and supplying operations are performed for all N signal branches.

### FIELD OF THE INVENTION

The present invention relates to error adjustment in direct conversion architectures. In particular, the invention relates to In-phase and Quadrature-phase based error adjustment using an envelope based In-phase and Quadrature-phase extraction in a multi-antenna transmitter.

### BACKGROUND OF THE INVENTION

The use of digital wireless communication systems has recently been increasing. Systems of many different types have been introduced. For example, systems like Wireless LANs (Local Area Networks), Wireless MANs (Metropolitan Area Networks), digital radio DVB-T are gaining more attention and users are given more alternatives in wireless communication. To get customers interested in new services it is essential that the equipment needed in order to use the services should be priced correctly. Transceivers with low cost and low power consumption are thus needed.

The Institute of Electrical and Electronics Engineers (IEEE) has developed new specifications 802.11a and 802.16a, which represent the next generation of enterprise-class wireless local and metropolitan area networks, respectively. Among the advantages it has over current technologies are greater scalability, better interference immunity, and significantly higher speed, which simultaneously allows for higher bandwidth applications. OFDM (Orthogonal Frequency Division Multiplex) is used as a new encoding scheme which offers benefits over spread spectrum in channel availability and data rate. Channel availability is significant because the more independent channels that are available, the more scalable the wireless network becomes. The high data rate is accomplished by combining many lower-speed subcarriers to create one high-speed channel. A large (wide) channel can transport more information per transmission than a small (narrow) one. The subcarriers are transmitted in parallel, meaning that they are sent and received simultaneously. The receiving device processes these individual signals, each one representing a fraction of the total data that, together, make up the actual signal. With this many subcarriers comprising each channel, a tremendous amount of information can be sent at once.

The IEEE 802.11a, 802.16a wireless LAN, MAN standard defines a high system performance and therefore requires a certain signal accuracy for the OFDM transmitter output. Taking the analog base-band and radio frequency (RF) filter imperfections into account it is necessary to equalize the signal stream before transmission. The performance of a transmitter output signal is strongly dependent on the analog filter accuracy. To reach high signal accuracy, expensive and precise filters have to be used. However, in high volume products it is recommended to have those filters as cheap as possible. It may be possible to insert low-cost and non-precise analog transmitter filters if a digital adaptive equalizer is installed to compensate large amplitude ripple and group delay in the transmitter pass-band.

A solution in affordable transmitters is the use of a direct conversion analog front-end architecture in the transmitters. In the direct conversion solution, a digital base band signal is digital-to-analog converted and afterwards mixed into an RF signal. For the mixing process, two signals, a sine and a cosine signal, have to be provided. Because of technical reasons the precise orthogonality of both sinusoidal signals cannot be guaranteed; therefore an angle φ≠90° is measurable between the sine and cosine functions. This phenomenon is commonly called quadrature error. In addition, also an IQ amplitude imbalance arises between the I-branch and the Q-branch.

Moreover, analog base band components, such as analog filters, are always installed twice: one component for the I-branch and one component for the Q-branch. Because of manufacturing tolerances, different age or temperature influences, each component of a certain functional type may behave slightly differently compared with its counterpart on the other branch. Additionally, low-cost analog filters may contain amplitude ripple, non-linear phase and they may insert ISI (Inter Symbol Interference).

As an example, FIG. 9 shows a graph illustrating an I-branch and Q-branch ISI generated by analog filters in a direct conversion analog front-end OFDM transmitter. No IQ phase or IQ amplitude imbalance errors are inserted so that only analog filter imperfections are visible.

The conjunction of frequency dependent base band devices with the constant IQ phase and amplitude imbalance imperfections result in frequency selective IQ phase and amplitude imbalance inaccuracies.

The phase and amplitude imbalance problem is present in any system employing direct conversion transmitters regardless of the modulation scheme or the multiple access solution. Particularly in a multicarrier system, such as WLAN, WMAN, which uses OFDM, the problem is particularly severe, although it also affects single carrier systems, such as GSM or cable modems.

To provide the required high signal accuracy in transmitters in order to fulfill certain performance requirements at the receiver side it has to be guaranteed that analog direct conversion front-end imperfections, such as quadrature error and amplitude imbalance errors, will be minimal.

Moreover, in direct conversion analog front-end transmitters it is necessary to pre-correct the transmitted signal stream via fully digital adjustment loops. To find the appropriate error values the transmitter output signal has to be measured e.g. at the transmitter antenna input port and fed back to the transmitter digital domain.

In addition, multi-antenna systems provide the option to enhance the data rates and to improve the overall system performance. Therefore it is important that the transmitter provides high signal accuracy for all different signal branches.

### SUMMARY OF THE INVENTION

It is an object of the invention to provide an improved error adjustment method and apparatus, by means of which the signal accuracy at a direct conversion architecture output can be improved to thereby reduce analog filter requirements in particular in a multi-antenna transmitter.

A further object of the invention is to improve the signal accuracy at a direct conversion architecture output of a multi-antenna transmitter and at the same time reduce an implementation amount of the multi-antenna transmitter.

According to an aspect of the invention, these objects are achieved by an error adjustment system for equalizing transmission characteristics of N signal processing circuitries according to N signal branches (N>1), the system comprising:

generating means for generating an original complex IQ signal for N signal branches;

N error correction means according to the N signal branches, each for performing error correction on the original complex IQ signal of a respective signal branch by means of a correction function;

N signal processing circuitries according to the N signal branches, each for processing the corrected complex IQ signal of the respective signal branch, thereby obtaining a processed real signal of the respective signal branch; and

a processing device comprising:

receiving means for receiving an original complex IQ signal of a signal branch of the N signal branches generated by the generating means and a processed real signal of the signal branch;

first calculating means for calculating a processed complex IQ signal of the signal branch from the processed real signal and the original complex IQ signal of the signal branch;

second calculating means for calculating a difference between the processed complex IQ signal and the original complex IQ signal;

third calculating means for calculating control values of a correction function of the signal branch on the basis of the difference calculated by the second calculating means; and

supplying means for supplying the control values calculated by the third calculating means to the correction function of the signal branch,

wherein the receiving means, the first to third calculating means and the supplying means are configured to repeat their operations for all N signal branches.

According to another aspect of the invention, the above objects are achieved by a processing device for an error adjustment system for equalizing transmission characteristics of N signal processing circuitries according to N signal branches (N>1), the device comprising:

receiving means for receiving an original complex IQ signal of a signal branch of N signal branches and receiving a processed real signal of the signal branch;

first calculating means for calculating a processed complex IQ signal of the signal branch from the processed real signal and the original complex IQ signal of the signal branch;

second calculating means for calculating a difference between the processed complex IQ signal and the original complex IQ signal;

third calculating means for calculating control values of a correction function of the signal branch on the basis of the difference calculated by the second calculating means; and

supplying means for supplying the control values calculated by the third calculating means to the correction function of the signal branch,

wherein the receiving means, the first to third calculating means and the supplying means are configured to repeat their operations for all N signal branches.

According to a further aspect of the invention, the above objects are achieved by an error adjustment method of equalizing transmission characteristics of N signal processing circuitries according to N signal branches, the method comprising:

a generating step of generating an original complex IQ signal for N signal branches; and

in each of the N signal branches:

a performing step of performing error correction on the original complex IQ signal by means of a correction function;

a processing step of processing the corrected complex IQ signal in a signal processing circuitry, thereby obtaining a processed real signal; and

in a processing device:

a receiving step of receiving an original complex IQ signal of a signal branch of the N signal branches generated in the generating step and a processed real signal of the signal branch;

a first calculating step of calculating a processed complex IQ signal of the signal branch from the processed real signal and the original complex IQ signal of the signal branch;

a second calculating step of calculating a difference between the processed complex IQ signal and the original complex IQ signal;

a third calculating step of calculating control values of a correction function of the signal branch on the basis of the difference calculated in the second calculating step;

a supplying step of supplying the control values calculated in the third calculating step to the correction function of the signal branch; and a repeating step of repeating the steps performed in the processing device for all N signal branches.

According to a still further aspect of the invention, the above objects are achieved by a method of equalizing transmission characteristics of N signal processing circuitries according to N signal branches, the method comprising:

a first calculating step of calculating a processed complex IQ signal of a signal branch of N signal branches from a processed real signal and an original complex IQ signal of the signal branch;

a second calculating step of calculating a difference between the processed complex IQ signal and the original complex IQ signal;

a third calculating step of calculating control values of a correction function of the signal branch on the basis of the difference calculated in the second calculating step; and

a repeating step for repeating the first to third calculating steps for all N signal branches.

The above objects may also be achieved by a computer program product for a computer, comprising software code portions for performing the following steps when the program is run on the computer:

a first calculating step of calculating a processed complex IQ signal of a signal branch of N signal branches from a processed real signal and an original complex IQ signal of the signal branch;

a second calculating step of calculating a difference between the processed complex IQ signal and the original complex IQ signal;

a third calculating step of calculating control values of a correction function of the signal branch on the basis of the difference calculated in the second calculating step; and

a repeating step for repeating the first to third calculating steps for all N signal branches.

According to the invention, an implementation amount of N filter pre-equalizers including IQ sample estimation for N signal branches in a multi-antenna transmitter can be reduced to one filter pre-equalizer including IQ sample estimation.

Further advantages of the invention are:
Low gate count because hardware (CPU+BUS) can be reused for any of N multi-transmitter branches;
High algorithm flexibility, because algorithms can be changed after architecture implementation has been finalized; and
Low power consumption, because parallel processing of N branches is converted to serial processing for N branches.

In the following the present invention will be described by means of preferred embodiments thereof taking into account the accompanying drawings in which same parts are indicated by same reference signs.

### BRIEF DESCRIPTION OF THE DRAWINGS

FIG. 1 shows a schematic block diagram illustrating an architecture of a multi-antenna OFDM transmitter employing error adjustment.

FIG. 2 shows a schematic block diagram illustrating an architecture of a multi-antenna OFDM transmitter employing error adjustment according to an embodiment of the invention.

FIG. 3 shows a schematic block diagram illustrating a processing device of the transmitter according to the embodiment of the invention.

FIG. 4 shows a flow chart illustrating a method of performing error adjustment according to the embodiment of the invention.

FIG. 5 shows a schematic block diagram illustrating an architecture of a multi-antenna OFDM transmitter employing error adjustment according to an implementation example of the invention.

FIG. 6 shows a diagram illustrating gradients on a level curve diagram.

FIG. 7 shows a diagram illustrating a gradient behavior from a bird's eye view.

FIG. 8 shows a diagram illustrating an estimated I-branch error during an adaptation process of a pre-equalizer.

FIG. 9 shows a diagram illustrating imperfect 16-QAM constellation points.

FIG. 10 shows a diagram illustrating 16-QAM constellation points when applying a 3-coefficient pre-equalizer.

FIG. 11 shows a diagram illustrating perfect pre-equalized 16-QAM constellation points.

FIG. 12 shows a diagram illustrating 16-QAM BER curves with different pre-equalizer coefficient numbers.

### DESCRIPTION OF THE PREFERRED EMBODIMENTS

The embodiments of the invention can be applied in any data transmission system employing direct conversion architectures. Examples of such systems include Wireless LANs (Local Area Networks), Wireless MANs (Metropolitan Area Networks), digital radio DVB-T. A direct conversion architecture arranged, for example, in a transmitter, is an architecture where a base band frequency is converted directly to a radio frequency (RF) signal to be transmitted without any intermediate frequency (IF) conversion in between.

As an example of a system to which the embodiments of the invention may be applied, a Wireless Local Area Network (WLAN), Wireless Metropolitan Area Network (WMAN) is studied. WLAN, WMAN is a data transmission medium that uses radio waves in connecting computers to a network. The backbone network is usually wire line and the wireless connection is the last link of the connection between the LAN and users.

If the system requires high data-rates and a good system-performance it is advantageous to employ a multi-antenna approach. To fulfill all requirements good signal accuracy already at the transmitter output has to be guaranteed. This is problematical if a low-cost direct conversion architecture has been chosen, which offers a cheap and low-power implementation with the drawback of imperfect I- and Q-signal accuracies. Reasons for the imperfections can be imperfect analog base band filters and unbalanced I- and Q-branch amplification.

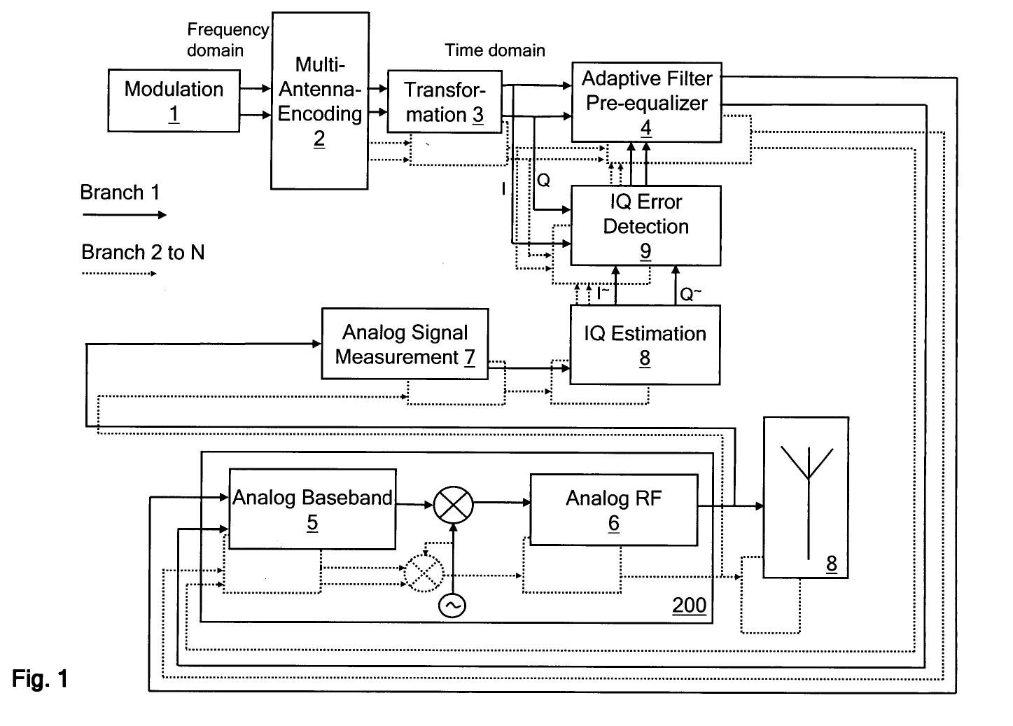

FIG. 1 illustrates an example of a front end for an IEEE802.11a OFDM direct conversion multi-antenna transmitter according to an embodiment of the invention.

According to FIG. 1, an In-phase component (I-signal) and a Quadrature-phase component (Q-signal) of a digital base band signal which has been subjected to modulation in block 1 such as binary phase shift keying (BPSK), quadrature phase shift keying (QPSK) or quadrature amplitude modulation (QAM) are fed to a multi-antenna encoding block 2 which may insert diversity or spatial-multiplexing approaches and provides I- and Q-signals for N signal branches of the multi-antenna transmitter. For each signal branch 1 to N, the I-signal and the Q-signal are transformed from frequency domain to time domain in block 3, e.g. by applying an Inverse Fast Fourier Transform (IFFT) on the I- and Q-branch. The time domain IQ signal components then are fed to an adaptive filter pre-equalizer 4 and an IQ error detection block 9. By means of the adaptive filter pre-equalizer 4 the IQ signal stream is corrected or pre-equalized such that distortions generated by non-ideal analog filter circuits of the following stages are eliminated. From the adaptive filter pre-equalizer 4 the pre-equalized IQ signal components are supplied to a transmitter circuitry 200, in which the signal is processed for transmission via a transmission antenna 8.

The transmitter circuitry 200 comprises an analog base band circuit 5 in which the pre-equalized IQ signal components are prepared for transmission, e.g. by applying filtering, channel coding, pulse shaping or other suitable processing operations. Then, the processed analog IQ base band signal components are supplied to an up-conversion stage comprising a modulator or multiplier to which an up-conversion signal at an adjustable range of e.g. 2.0 to 11 GHz is supplied from a controllable oscillator. Thereby, the analog base band IQ signal components are up-converted to an adjustable frequency range of 2.0 to 11.0 GHz. The up-converted IQ signal components are combined and fed to a filter circuit, i.e. an analog RF filter circuit 6 adapted to pass only the desired frequency range of the transmission signal supplied to the transmission antenna 8.

In an analog signal measurement circuit 7 an envelope signal of the input signal of the transmission antenna 8 is obtained and the envelope signal is then converted into a digital signal stream supplied to an IQ estimation block 8. The IQ estimation block 8 computes estimated IQ signal components out of the real signal stream. The estimated IQ signal components I˜ and Q˜ are applied to the IQ error detection block 9 where they are used for IQ error detection.

As shown in FIG. 1, analog signal imperfections are removed digitally. In the digital domain, the digital pre-equalizer 4 takes care about analog filter imperfections. This block is able to pre-modify the ideal digital data stream. The digital pre-modification effects will be compensated later by the introduction of the unwanted analog imperfections such that the final result at the antenna input port leads to an ideal signal. The pre-equalizer or digital pre-compensation block 4 derives its correction coefficients from an error detection algorithm (IQ error detection block 9), which calculates the error based on the comparison between ideal and real I- and Q-samples. Hence an I- and Q-sample estimation from the RF-envelope signal is required.

Multi-antenna systems provide the option to enhance the data rates and to improve the overall system performance. Therefore it is important that the transmitter provides high signal accuracy for all different signal branches 1 to N.

As shown in FIG. 1, each of the N multi-antenna branches requires its own error adjustment block and its own IQ estimation block. All components are implemented via dedicated hardware. No resource sharing is employed.

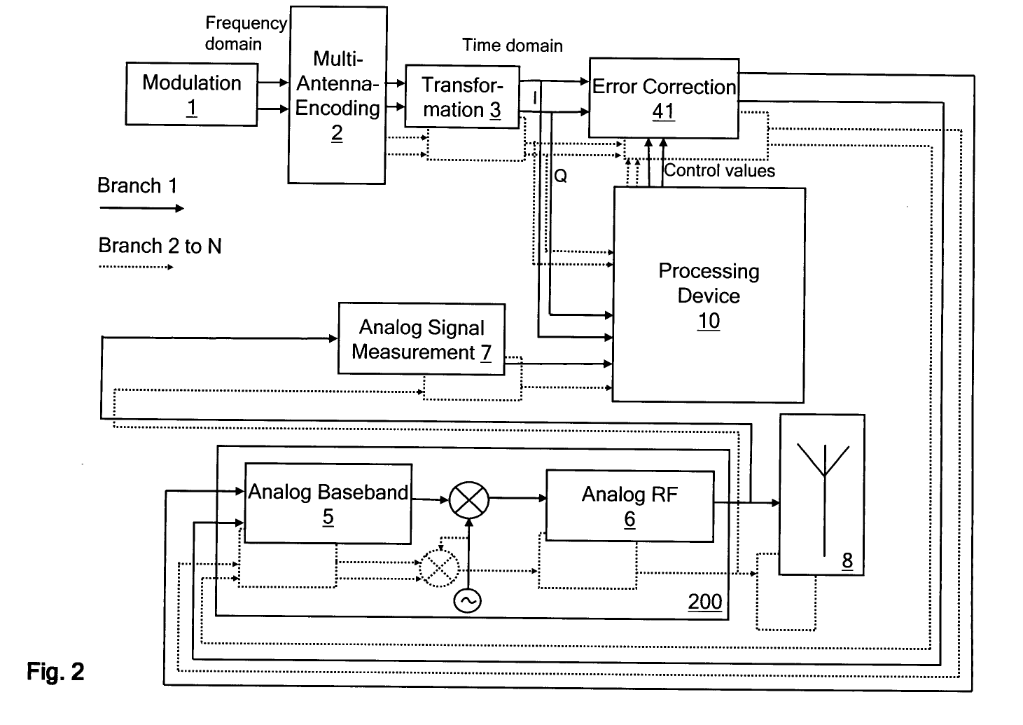

According to the invention, a software-hardware approach is proposed which reduces the amount of N different pre-equalizers to only a single pre-equalizer implementation for the overall multi-antenna transmitter. This software-hardware approach is shown in FIG. 2, which illustrates an embodiment of the invention.

As shown in FIG. 2, the IQ estimation block 8 for each signal branch 1 to N, the IQ error detection block 9 for each branch 1 to N as well as a part of the pre-equalizer 4 for calculating control values, which lead to updated filter coefficients, are replaced by a processing device 10.

Hence the implementation amount of N filter pre-equalizers 4, N IQ error detection blocks 9 and N IQ sample estimation blocks 8 is reduced to one processing device 10 including IQ sample estimation, IQ error detection and the calculation of control values and N error correction blocks 41 for correcting the IQ signal stream from the transformation block 3 on the basis of the control values calculated by the processing device 10.

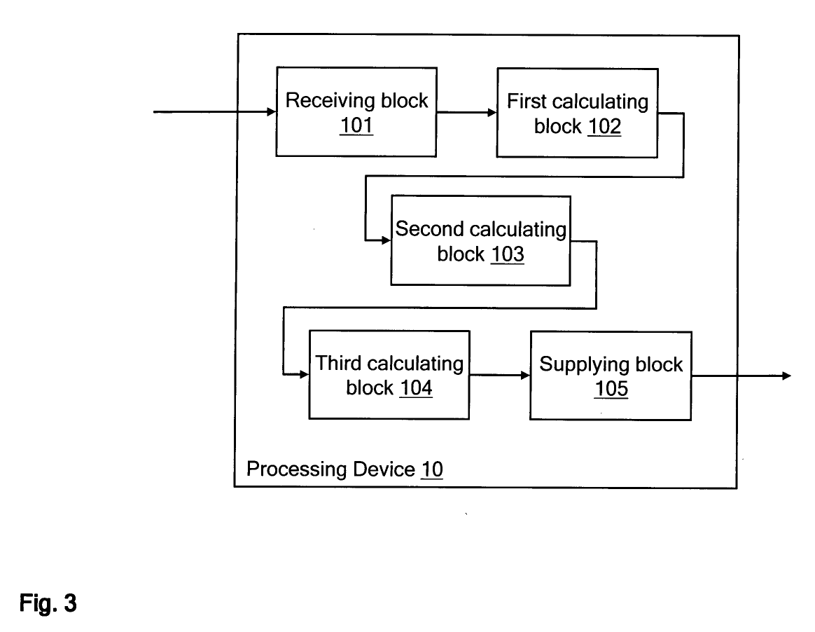

The processing device 10 shown in FIG. 2 will be described in greater detail by referring to FIG. 3. The processing device 10 comprises a receiving block 101 for receiving an original complex IQ signal I,Q of a signal branch (e.g. branch 1) of the N signal branches from the transformation block 3 and a processed real signal of the signal branch from the analog signal measurement block 7. In a first calculating block 102 of the processing device 10 a processed complex IQ signal I˜,Q˜ of the signal branch is calculated from the processed real signal and the original complex IQ signal I,Q of the signal branch. In a second calculating block 103 of the processing device 10 a difference between the processed complex IQ signal I˜,Q˜ and the original complex IQ signal I,Q is calculated. Then, in a third calculating block 104 of the processing device 10 control values of a correction function of the signal branch are calculated on the basis of the difference calculated by the second calculating block 103. Finally, a supplying block 105 of the processing device 10 supplies the control values calculated by the third calculating block 104 to the error correction block 4 of the signal branch.

Then, the operations of the receiving means, the first to third calculating means and the supplying means are repeated for the next signal branch (e.g. branch 2), etc. When the control values for all branches 1 to N have been calculated and supplied, the processing is started again with branch 1.

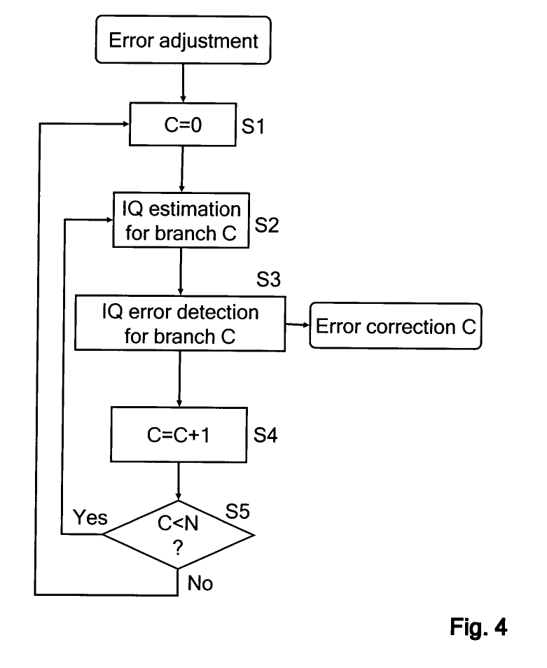

FIG. 4 shows a flow chart illustrating error adjustment processing according to the embodiment of the invention. In a first step S1 a count value C of a signal branch counter is set to zero. When the counter has reached the number C=N the calculations start with the first signal branch again. In step S2, IQ estimation for an actual signal branch C is carried out by the first calculating block 102. In step S3, IQ error detection for the actual branch C is carried out by the second and third calculating blocks 103 and 104 and the calculated control values are supplied to an error correction in the error correction block 4 of the actual branch C.

In step S4 the count value C is incremented by 1. In case it is detected in step S5 that the count value C is smaller than the number of signal branches N the process returns to step S2 for performing processing for the next signal branch. In case the count value C is not smaller than the number of signal branches N the process returns to step S1 for starting with the first signal branch again.

In the following a short description of filter pre-equalization is given which is adopted to pre-modify the ideal digital data stream I,Q as mentioned above. More details about this filter pre-equalization are described in applicant's patent applications PCT/IB/02/02775 and U.S. Ser. No. 10/408,106 the disclosure of which is incorporated herein by reference.

Filter pre-equalization is different to channel pre-equalization. It does not operate with complex coefficients, but with real ones. Thereby it is possible to handle I-branch and Q-branch imperfections independently. The I-branch and Q-branch filter imperfections are generated by the analog base band filters, which are two real filters. The IQ amplitude error detection will be done via equation (3) to be described later.

To update filter coefficients of an adaptive filter pre-equalizer successfully the gradient has to be calculated based on an approximated system identification. The approximation of the analog filters will be simple tap-delay lines providing the same latency as the analog filters contain. Equation (1) provides the gradient of the LMS (least-mean-square) approach.
\hat{∇}{Ê<e²[n]>}=−2·e[n]·D[n]·h^{#}[n] (1)
wherein e is an error value, D is an ideal input data matrix, and h^{#} is an approximation of analog filters h_{I} and h_{Q} of the adaptive filer pre-equalizer.

Based on the gradient there can be calculated an update of pre-equalizer filter coefficients. There have to be calculated for both branches independent correction coefficients. This is described by equation (2). The new coefficients c_{I,Q}[n+1] at the time n+1 will be calculated from the current coefficients c_{I,Q}[n] at the time n and an additional addend.
c_{I,Q}[n+1]=c_{I,Q}[n]+μe_{I,Q}[n]D_{I,Q}[n]h_{I,Q}^{#}[n] (2)

The addend consists out of four factors. First the constant μ describes a step width. The step width defines the loop accuracy, loop adaptation speed or loop bandwidth, respectively. Because the expected filter imperfections will not change over a very long period of time the loop bandwidth needs not to be large and hence the loop accuracy can be high.

The second factor is the calculated error from equation (3) to be described later. After that the product of the ideal input data matrix D and the approximation h^{#} of the analog filters h_{I,Q} follows. The new coefficient vector leads to a better signal equalization and when the optimum adaptive filter vector has been reached the adaptation loop is in equilibrium.

Combined with the digital IQ estimation to be described in the following there can be built an adaptive filter pre-equalization system enabling low cost analog front-ends.

Next, a short description of the digital IQ estimation is given. More details about this IQ estimation are described in applicant's patent application U.S. Ser. No. 10/408,106.

In direct conversion architectures the I- and Q-branches are fed from the digital base band via two independent DACs (Digital-Analog-Converters) to the analog base band. After separate low-pass filtering and appropriate amplification of each branch the up-conversion to the RF range takes place. In case of a multi-antenna system with N transmitter antennas this architecture has to be installed N times. At the N antenna outputs it is desired to have the best possible signal accuracy available. This can be reached by installing precise, but most probably expensive analog components for each I- and Q-branch and for each transmitter path. An advantageous alternative is the installation of low cost analog components with less precision and additionally digital compensation techniques to remove the analog imperfections via a cheap solution. Therefore I- and Q-signal extraction from the RF-envelope needs to be done. The extraction is required to estimate reliably the wanted IQ samples from the analog RF-envelope without a down-modulation process on the transmitter side.

The estimated IQ samples are used for the digital pre-equalization process. To pre-equalize the analog base-band filters there has to be employed filter imperfection estimation. Such an error detection may be done by subtracting non-ideal IQ samples Ĩ[n] and \tilde{Q}[n] from ideal IQ samples I[n] and Q[n].
e_{I}[n]=I[n]−Ĩ[n]
e_{Q}[n]=Q[n]−\tilde{Q}[n] (3)

In case of ideal output samples at the antenna port the differences between the wanted and the transmitted signals equals zero and no pre-equalization needs to be activated. Assuming that there are imperfections present then the difference is unequal to zero in both branches from equation (3). To enable the required measurement the non-ideal IQ samples have to be extracted from the analog envelope signal. This is done digitally by the following two rules. The I-branch value is calculated by
Ĩ[n]=s_{I}·\sqrt{Aₐ[n]²−\tilde{Q}}[n]² (4)
wherein Aₐ is the discrete base-band equivalent of the imperfect transmitter output.

The Q-branch estimate is based on

$$\tilde{Q} [ n ] = {s}_{Q} \sqrt{\frac{{Q [ n ]}^{2}}{{Q [ n - 1 ]}^{2}} \cdot \frac{{A}_{a}^{2} [ n - 1 ] \cdot \frac{{I [ n ]}^{2}}{{I [ n - 1 ]}^{2}} - {A}_{a}^{2} [ n ]}{\frac{{I [ n ]}^{2}}{{I [ n - 1 ]}^{2}} - \frac{{Q [ n ]}^{2}}{{Q [ n - 1 ]}^{2}}}} \qquad ( 5 )$$

First equation (4) has to be solved and after that equation (5) can be taken into account. The signals s_{I} and s_{Q} provide the digital sample signs. They have been stored in parallel and it is assumed that the analog imperfections will not disturb the sign of the analog samples. This will be almost true, because care is taken about imperfect analog filters and no random channels.

From the system cost perspective it is advantageous to implement filter pre-equalizer and IQ sample estimation algorithms as software code on a Digital-Signal-Processor (DSP) or ARM processor. The mathematical operations of these algorithms are good candidates to be handled by the DSP or ARM because the analog filter imperfections do not change quickly their imperfection values. Hence the IQ sample estimation, error calculation and the coefficient update need not to be done as quickly as practically possible. Changing the block based hardware implementation to a processor based software implementation it is possible to end up with a much more flexible and cost-reducing architecture by employing a DSP/ARM.

This is valid especially for multi-antenna transmitters. Here the implementation amount of N different filter pre-equalizers and N different IQ sample estimations can be reduced by a software approach, which requires only a DSP or ARM processor and a BUS system. Based on a low cost analog front-end in combination with digital, software-based pre-adjustment algorithms it is possible to guarantee a high output precision required by a multi-antenna transmitter.

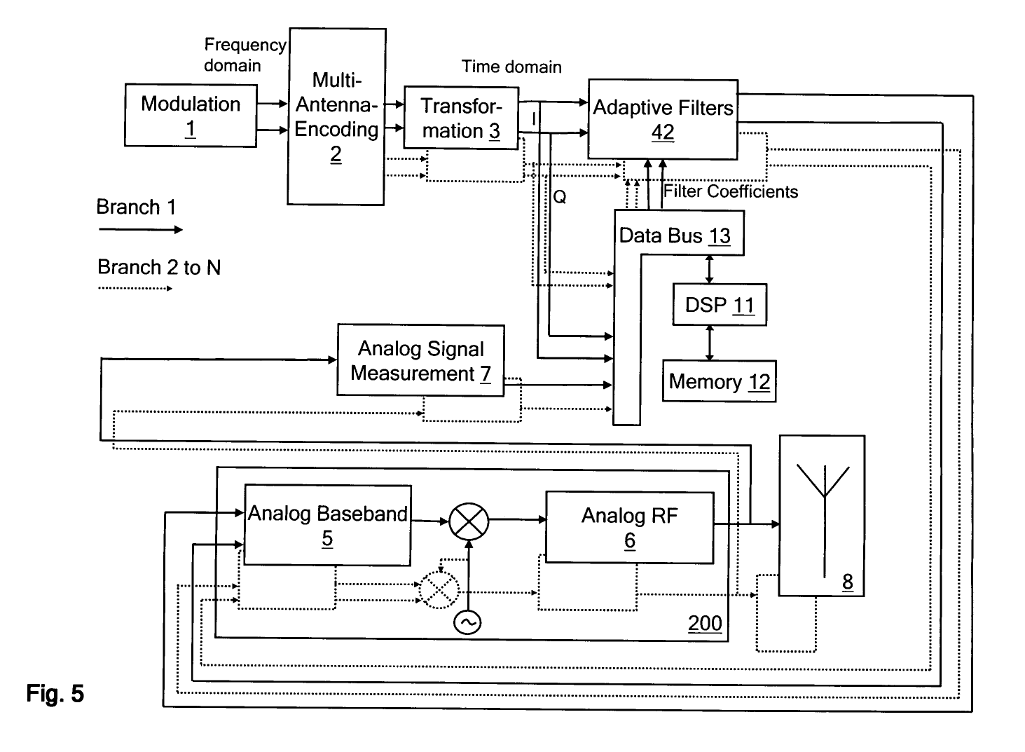

According to an implementation example as shown in FIG. 5, the invention provides a software approach for OFDM-based IQ sample estimation and filter pre-equalizer in a multi-antenna transmitter.

As mentioned above, algorithms which operate on high rate data should be implemented via dedicated hardware. Operations which do not require such high rates can implemented via software on a Digital-Signal-Processor (DSP) or ARM.

Adaptive filters of the pre-equalizer 4 of FIG. 1, which is placed behind the transformation block 3 such as an IFFT, operate on a high rate payload data stream. Thus, the adaptive filters themselves should be implemented via dedicated hardware. In contrast thereto, the mathematical operations from equations (2), (3), (4) and (5) are good candidates to be handled by the DSP. This is true because the analog filter imperfections do not change quickly. Hence there is no need to update the IQ sample estimation, error calculation and coefficient update as quick as possible. Based on the overall system requirements it can be expected that the update rate for equations (2), (3), (4) and (5) is much slower than the payload data rate.

Changing the system block diagram shown in FIG. 1 to a hardware-software partitioning description it is possible to end up with a much more flexible and cost-reducing architecture by employing a processing device 10 as shown in FIG. 2 which may comprise a DSP 11 as shown in FIG. 5.

FIG. 5 shows a software-based transmitter part for the IQ sample estimation, the error detection as well as the coefficient update of a pre-equalizer. A data bus 13 establishes the connections between the DSP 11 and the envelope input signal from the analog signal measurement block 7 and the adaptive filters 42 of the pre-equalizer, respectively. Instructions for the different algorithms are stored in a memory 12. Additional control software which is responsible to guarantee a correct order of the different algorithm operations is provided as well. Besides the instructions the DSP requires the data from the digital base band and the analog front-end. This data is also stored in the memory 12 and used by the DSP instructions to calculate a new filter coefficient update.

Once the filter coefficients have been updated they can be provided via the data bus 13 to the adaptive filters 42. The filters are still implemented via dedicated hardware because the signal pre-modification needs to operate on the base of a user data rate. From the instructions point of view the DSP could handle the adaptive filtering process as well. But in that case a significant higher processor clock rate has to be considered. Such a high clock rate might increase the power consumption of the DSP to an undesired value.

Because of the multi-antenna approach the pre-equalization has to be performed for all N-transmitter branches. From the pure hardware perspective this means that N different pre-equalizer feedback loops have to be implemented. However, considering that the analog filters change their imperfection values very slowly the digital IQ sample estimations and digital pre-equalizer error detections can be calculated one after another for all N different transmit branches. To optimize the overall implementation it is advantageous to implement the IQ sample estimation and the pre-equalizer error calculation by means of a DSP/ARM software as shown in FIG. 5. In contrast thereto, in a pure hardware approach the overall processing of all branches is done in parallel.

The software processing according to the implementation example of the invention is described by referring again to FIG. 4. The processing starts in step S by setting a count value C of a counter to zero. When the counter has reached the number C=N (NO in step S5) the calculations start with the first signal branch again.

Step S2 provides an IQ sample estimation from equation (4) and equation (5) for an actual branch C, C denoting a value in-between 0 . . . N−1. Estimated IQ values in step S2 are handed over to a pre-equalizer coefficient update from equation (2) (step S3). Based on the IQ values in step S3 a new set of filter coefficients is transferred from the DSP 11 to the hardware implementation of the adaptive filters 42 (error correction C) of the pre-equalizer of the actual branch C. Finally in step S4 the count value C is incremented. Hence the next adaptive pre-equalizer filters 42 of branch C+1 of the N multi-antenna branches is served by the software calculation.

The DSP/ARM software approach is based on the certainty that the analog imperfections change slowly and hence enough time for a serial calculation approach is available. This circumstance can be exploited by the proposed software approach and provides a high implementation reuse factor.

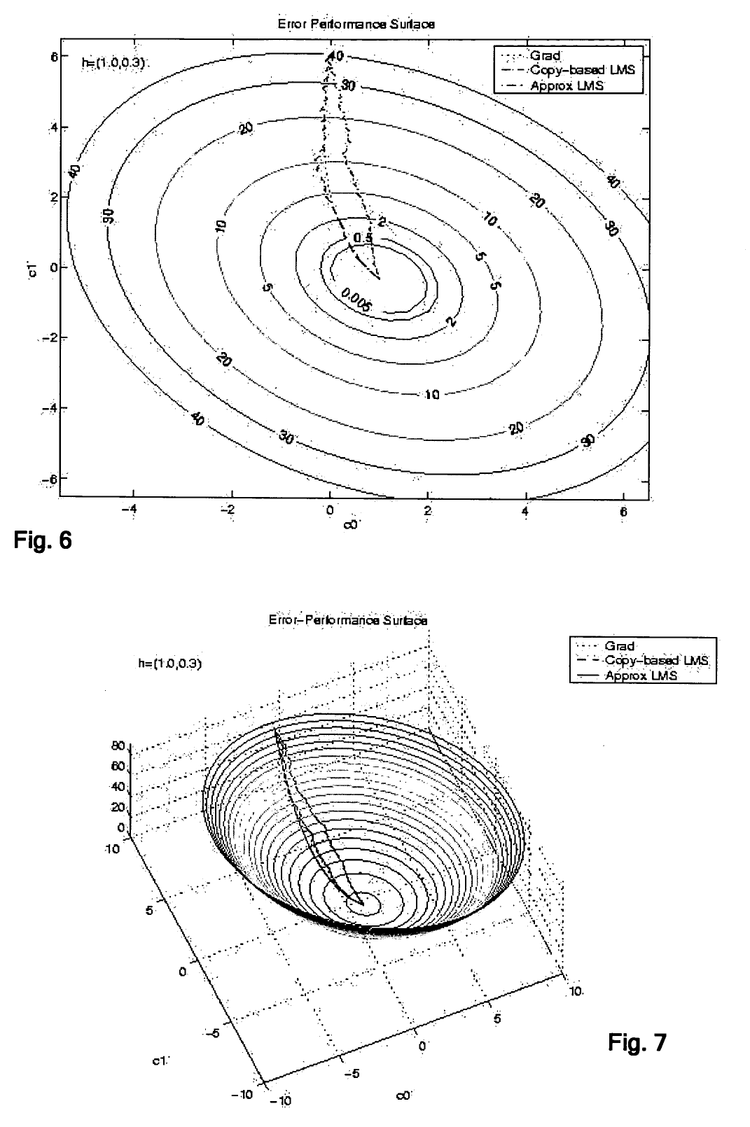

As described above with respect to the filter pre-equalization, the approximation-based gradient is updated on a sample-by-sample basis and depends on the measured error value e[n] and the delayed input signal. The mentioned delay corresponds to an approximated analog filter peak. FIG. 6 provides the difference between the proposed pre-equalizer with an approximation-based gradient, a gradient based on an ideal system identification and a deterministic gradient.

As shown in FIG. 6, the approximation-based gradient takes a different route but reaches an optimal filter vector as the other algorithms. FIG. 7 shows the three gradients from another camera position.

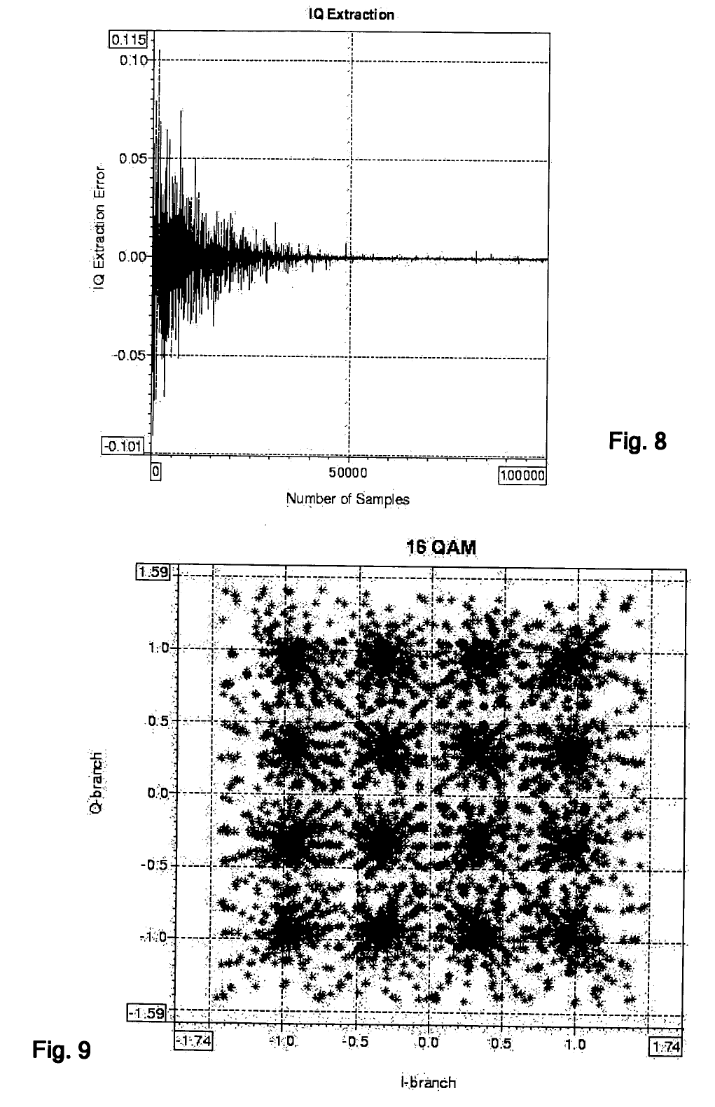

FIG. 8 provides the differences between ideal and estimated I-values during a pre-equalizer adaptation process. After all filter imperfections have been compensated by the pre-equalizer there has been left no differences between the ideal and estimated I-values.

The system performance for an IEEE802.16a based OFDM system including 16-QAM is analysed in the following. Because of a low cost direct-conversion analog front-end imperfect analog base band filters are assumed. There can be expected a significant decrease of the transmitted signal accuracy. FIG. 9 shows possible inaccuracies for a 16-QAM signal.

After the pre-equalization process has been enabled the imperfections are reduced significantly already by a 3-coefficient adaptive filter. FIG. 10 shows that the constellation points are much more precise but not perfect.

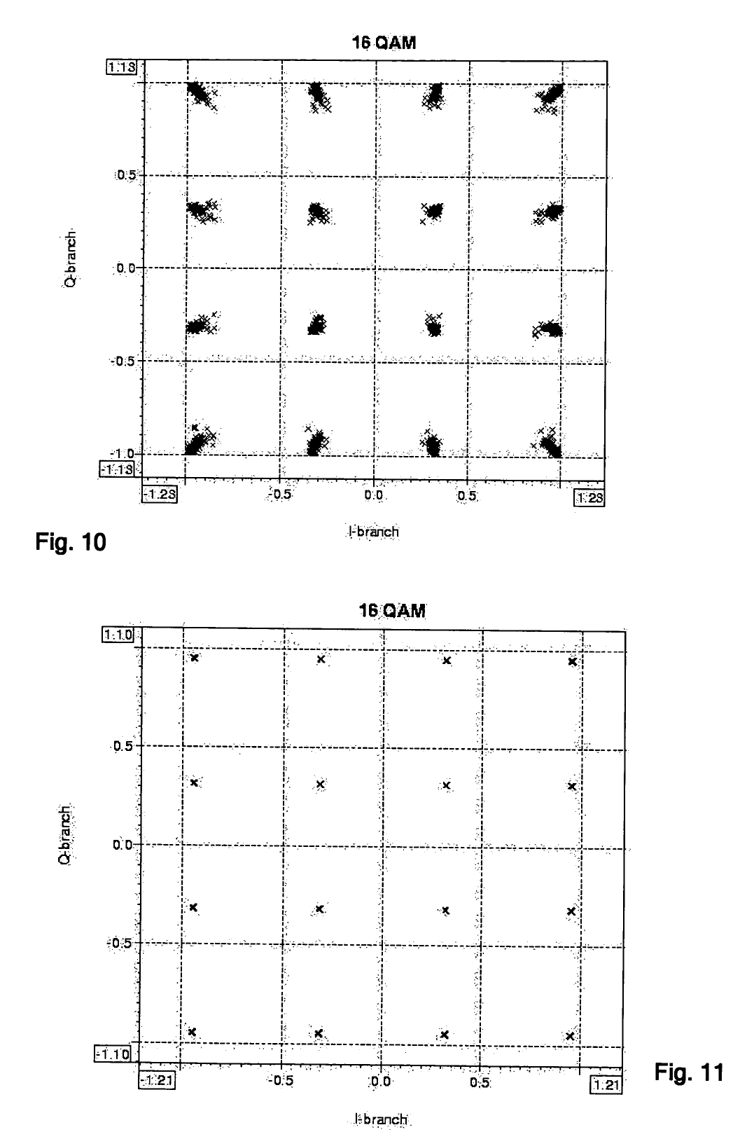

By employing 19 coefficients a perfect signal accuracy at the transmitter output can be reached. This is shown in FIG. 11. Hence a digital adaptive filter can allow the use of low-cost, imperfect analog filters.

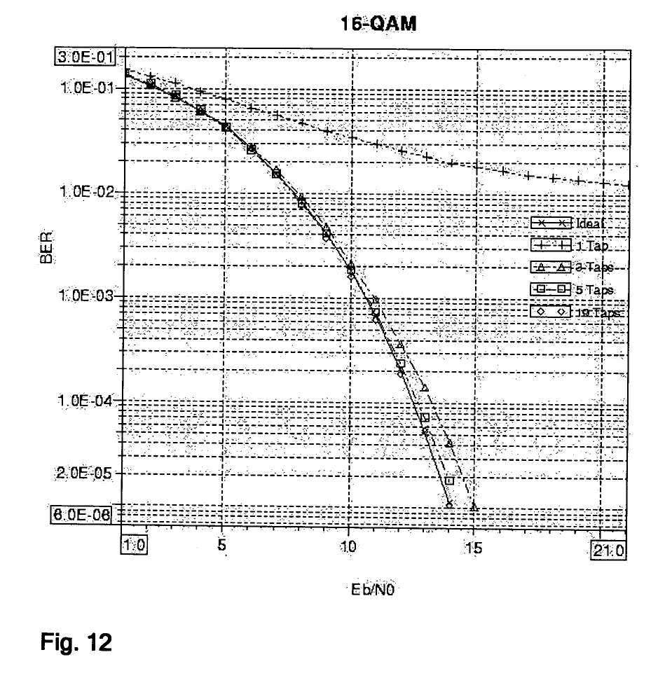

Besides the signal accuracy it is possible to measure the imperfections via BER (Bit-Error-Rate) curves as well. FIG. 12 provides simulation results for a 16-QAM.

Non-frequency selective corrections employ only one coefficient and cannot remove the imperfect analog filter influences. They adjust just the signal amplitude. A BER floor makes the overall transmitter performance poor. Increasing the number of pre-equalizer coefficients leads to better performances. With 19 coefficients the desired performance is provided.

It has been shown that the overall system performance decreases significantly by introducing low-cost analog filters. Finally a 19-coefficients filter pre-equalizer can remove the imperfections and high signal accuracy at the transmitter output can be reached.

It is to be understood that the above description is illustrative of the invention and is not to be construed as limiting the invention. Various modifications and applications may occur to those skilled in the art without departing from the true spirit and scope of the invention as defined by the appended claims.

1. An error adjustment system for equalizing transmission characteristics of N signal processing circuitries according to N signal branches (N>1), the system comprising:
generating means for generating an original complex IQ signal for N signal branches;
N error correction means according to the N signal branches, each for performing error correction on the original complex IQ signal of a respective signal branch by means of a correction function;
N signal processing circuitries according to the N signal branches, each for processing the corrected complex IQ signal of the respective signal branch, thereby obtaining a processed real signal of the respective signal branch; and
a processing device comprising:
receiving means for receiving an original complex IQ signal of a signal branch of the N signal branches generated by the generating means and a processed real signal of the signal branch;
first calculating means for calculating a processed complex IQ signal of the signal branch from the processed real signal and the original complex IQ signal of the signal branch;
second calculating means for calculating a difference between the processed complex IQ signal and the original complex IQ signal;
third calculating means for calculating control values of a correction function of the signal branch on the basis of the difference calculated by the second calculating means; and
supplying means for supplying the control values calculated by the third calculating means to the correction function of the signal branch,
wherein the receiving means, the first to third calculating means and the supplying means are configured to repeat their operations for all N signal branches.

2. The system according to claim 1, further comprising:
N detecting means according to the N signal branches, for detecting an envelope of the processed real signal,
wherein the receiving means of the processing device are configured to receive the original complex IQ signal of the signal branch generated by the generating means and the envelope of the processed real signal of the signal branch, and
wherein the first calculating means are configured to calculate a processed complex IQ signal of the signal branch from the envelope of the processed real signal and the original complex IQ signal of the signal branch.

3. The system according to claim 2, wherein the first calculating means are configured to calculate an envelope of the original complex IQ signal of the signal branch and to comparing the envelope of the processed real signal with the envelope of the original IQ signal at two consecutive time instances, thereby obtaining a processed complex IQ signal.

4. The system according to claim 3, wherein the processing device further comprises synchronizing means for synchronizing the envelope of the processed real signal and the original complex IQ signal of the signal branch, and the first calculating means are configure to compare the envelope of the processed real signal synchronized with the original complex IQ signal with the envelope of the original IQ signal at two consecutive time instances, thereby obtaining a processed complex IQ signal.

5. The system according to claim 1, wherein the third calculating means are configured to approximate a gradient of the difference calculated by the second calculating means on the basis of the difference and an approximation of a transmission characteristic of the signal processing circuitry of the signal branch, and to update control values of the correction function based on the approximated gradient, and wherein the supplying means are configured to supply the updated control values to the correction function of the signal branch.

6. A processing device for an error adjustment system for equalizing transmission characteristics of N signal processing circuitries according to N signal branches (N>1), the device comprising:
receiving means for receiving an original complex IQ signal of a signal branch of N signal branches and receiving a processed real signal of the signal branch;
first calculating means for calculating a processed complex IQ signal of the signal branch from the processed real signal and the original complex IQ signal of the signal branch;
second calculating means for calculating a difference between the processed complex IQ signal and the original complex IQ signal;
third calculating means for calculating control values of a correction function of the signal branch on the basis of the difference calculated by the second calculating means; and
supplying means for supplying the control values calculated by the third calculating means to the correction function of the signal branch,
wherein the receiving means, the first to third calculating means and the supplying means are configured to repeat their operations for all N signal branches.

7. The processing device according to claim 6, wherein the receiving means and the supplying means are formed by a data bus, and wherein the first to third calculating means are formed by a digital signal processor.

8. The processing device according to claim 7, further comprising storage means for storing algorithms to be carried out by the digital signal processor.

9. An error adjustment method of equalizing transmission characteristics of N signal processing circuitries according to N signal branches, the method comprising:
a generating step of generating an original complex IQ signal for N signal branches; and
in each of the N signal branches:
a performing step of performing error correction on the original complex IQ signal by means of a correction function;
a processing step of processing the corrected complex IQ signal in a signal processing circuitry, thereby obtaining a processed real signal; and
in a processing device:
a receiving step of receiving an original complex IQ signal of a signal branch of the N signal branches generated in the generating step and a processed real signal of the signal branch;
a first calculating step of calculating a processed complex IQ signal of the signal branch from the processed real signal and the original complex IQ signal of the signal branch;
a second calculating step of calculating a difference between the processed complex IQ signal and the original complex IQ signal;
a third calculating step of calculating control values of a correction function of the signal branch on the basis of the difference calculated in the second calculating step;
a supplying step of supplying the control values calculated in the third calculating step to the correction function of the signal branch; and
a repeating step of repeating the steps performed in the processing device for all N signal branches.

10. The method according to claim 9, further comprising:
in each of the N signal branches:
a detecting step of detecting an envelope of the processed real signal,
wherein the receiving step comprises receiving the original complex IQ signal of the signal branch generated in the generating step and the envelope of the processed real signal of the signal branch, and
wherein the first calculating step comprises calculating a processed complex IQ signal of the signal branch from the envelope of the processed real signal and the original complex IQ signal of the signal branch.

11. The method according to claim 10, wherein the first calculating step comprises:
calculating an envelope of the original complex IQ signal of the signal branch; and
comparing the envelope of the processed real signal with the envelope of the original IQ signal at two consecutive time instances, thereby obtaining a processed complex IQ signal.

12. The method according to claim 11, further comprising:
in the processing device:
a synchronizing step of synchronizing the envelope of the processed real signal and the original complex IQ signal of the signal branch,
wherein the envelope of the processed real signal synchronized with the original complex IQ signal is compared with the envelope of the original IQ signal at two consecutive time instances, thereby obtaining a processed complex IQ signal.

13. The method according to claim 9, wherein the third calculating step comprises:
approximating a gradient of the difference calculated in the second calculating step on the basis of the difference and an approximation of a transmission characteristic of the signal processing circuitry of the signal branch; and
updating control values of the correction function based on the approximated gradient; and
the supplying step comprises supplying the updated control values to the correction function of the signal branch.

14. A method of equalizing transmission characteristics of N signal processing circuitries according to N signal branches, the method comprising:
a first calculating step of calculating a processed complex IQ signal of a signal branch of N signal branches from a processed real signal and an original complex IQ signal of the signal branch;
a second calculating step of calculating a difference between the processed complex IQ signal and the original complex IQ signal;
a third calculating step of calculating control values of a correction function of the signal branch on the basis of the difference calculated in the second calculating step; and
a repeating step for repeating the first to third calculating steps for all N signal branches.

15. A computer program product for a computer, comprising software code portions for performing the following steps when the program is run on the computer:
a first calculating step of calculating a processed complex IQ signal of a signal branch of N signal branches from a processed real signal and an original complex IQ signal of the signal branch;
a second calculating step of calculating a difference between the processed complex IQ signal and the original complex IQ signal;
a third calculating step of calculating control values of a correction function of the signal branch on the basis of the difference calculated in the second calculating step; and
a repeating step for repeating the first to third calculating steps for all N signal branches.

16. The computer program product according to claim 15, wherein the computer program product comprises a computer-readable medium on which the software code portions are stored.

17. The computer program product according to claim 15, wherein the computer program product is directly loadable into an internal memory of the computer.
